(19) United States
(12) Patent Application Publication
(10) Pub. No.: US 2014/0037014 A1
(43) Pub. Date: Feb. 6, 2014

(54) STREAM GENERATION APPARATUS AND STREAM GENERATION METHOD

(71) Applicant: Panasonic Corporation, Osaka (JP)

(72) Inventors: Hiroyuki MURATA, Shiga (JP); Kohei OKADA, Osaka (JP)

(73) Assignee: Panasonic Corporation, Osaka (JP)

(21) Appl. No.: 14/048,435

(22) Filed: Oct. 8, 2013

Related U.S. Application Data
(63) Continuation of application No. PCT/JP2012/002088, filed on Mar. 26, 2012.

(30) Foreign Application Priority Data
Apr. 11, 2011 (JP) 2011-087756

(51) Int. Cl. H04N 7/26

(52) U.S. Cl. CPC H04N 19/00957
USPC 375/240.23

(57) ABSTRACT

A stream generation apparatus, which generates a stream by performing variable-length coding and compression coding on input data, includes: an inserting unit which inserts, into input data, coding-related information which is information to be used for compression coding of quantized data; a first coding unit which performs first processing including variable-length coding and compression coding of headers; a first transfer control unit which transfers, to a storage unit, intermediate data which is the input data on which the first processing has been performed; a second transfer control unit which reads the intermediate data from the storage unit; an extracting unit which extracts information indicated by the coding-related information from the intermediate data; and a second coding unit which generates a stream by performing second processing including compression coding of the quantized data using the information extracted by the extracting unit.

### CROSS REFERENCE TO RELATED APPLICATIONS

This is a continuation application of PCT International Application No, PCT/JP2012/002088 filed on Mar. 26, 2012, designating the United States of America, which is based on and claims priority of Japanese Patent Application No. 2011-087756 filed on Apr. 11, 2011. The entire disclosures of the above-identified applications, including the specifications, drawings and claims are incorporated herein by reference in their entirety.

### FIELD

The present invention relates to a stream generation apparatus and a stream generation method in an information processing apparatus which includes image coding functions.

### BACKGROUND

Along with expansion of network bandwidth and increase in size of displays, recent years have seen the appearance of full high definition (Full-HD) size video content items as video content items transmitted via networks.

However, personal computers (PCs) do not yet have enough capabilities to code or decode Full-HD moving pictures in real time; and thus, a dedicated hardware needs to perform part of the processing.

The recent mainstream for coding schemes of moving pictures is image coding schemes which comply with the H.264/AVC standard (hereinafter referred to as H.264 coding scheme). The H.264 coding scheme is capable of significantly increasing the coding efficiency by using arithmetic coding that is not used in conventional standards such as MPEG-2.

One of the conventional image coding apparatuses which perform arithmetic coding is an apparatus which sequentially performs coding on input data including header information and quantized data in units of pictures. For example, Patent Literature 1 discloses such an apparatus.

### CITATION LIST

### Patent Literature

[Patent Literature 1] U.S. Pat. No. 7,369,066

### SUMMARY

### Technical Problem

Here, for example, when a stream including moving picture data is transmitted via a network, it is necessary to generate a stream with high tolerance to transmission errors. However, at present, for example, it is difficult to generate such a stream by a coding scheme which involves arithmetic coding.

In view of the conventional problem, one non-limiting and exemplary embodiment provides a stream generation apparatus which is capable of efficiently generating a stream having both high error tolerance and high compression rate.

### Solution to Problem

In order to solve the conventional problem, a stream generation apparatus according to one aspect of the present invention is a stream generation apparatus which generates a stream by performing variable-length coding and compression coding on input data including quantized data which is quantized image data and a header corresponding to the quantized data. The stream generation apparatus includes: an inserting unit which inserts, into the header, coding-related information which is information for identifying a position of necessary information in the header, the necessary information being information necessary for the compression coding of the quantized data; a first coding unit which performs first processing on the input data in a state before or after the insertion of the coding-related information, the first processing including the variable-length coding and the compression coding of the header; a first transfer control unit which transfers intermediate data to a storage unit connected to the stream generation apparatus, the intermediate data being the input data which includes the coding-related information and on which the first processing has been performed; a second transfer control unit which reads the intermediate data from the storage unit; an extracting unit which extracts the necessary information from the position in the header indicated by the coding-related information, the header being included in the read intermediate data; and a second coding unit which generates the stream by performing second processing including the compression coding of the quantized data which is included in the read intermediate data and on which the first processing has been performed, the compression coding being performed using the necessary information extracted by the extracting unit.

These general and specific aspects may be implemented using a system, a method, an integrated circuit, a computer program, or a recording medium, or any combination of systems, methods, integrated circuits, computer programs, or recording media.

### Advantageous Effects

The stream generation apparatus according to one aspect of the present invention is capable of efficiently generating a stream having both high error tolerance and high compression rate.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a diagram showing an example of a configuration of an audio and visual (AV) system which includes an image coding unit according to Embodiment 1.

FIG. 2 is a block diagram schematically showing a configuration of an image coding apparatus according to Embodiment 1.

FIG. 3 is a block diagram schematically showing a configuration of the image coding unit according to Embodiment 1.

FIG. 4 is a block diagram schematically showing a configuration of a stream generation apparatus according to Embodiment 1.

FIG. 5 is a diagram showing an example of a structure of intermediate data that is transferred to a main memory from a preceding unit, according to Embodiment 1.

FIG. 6 is a flowchart of an example of processing performed by the image coding unit according to Embodiment 1.

FIG. 7A is a flowchart of an example of processing in coding_{—}1 shown in FIG. 6.

FIG. 7B is a flowchart of an example of processing in coding_{—}2 shown in FIG. 6.

FIG. 8 is a diagram showing an example of a structure of intermediate data that is transferred to a main memory from a preceding unit, according to Embodiment 2.

FIG. 9 is a flowchart of an example of processing in coding_{—}1 according to Embodiment 2.

FIG. 10 is a diagram showing an example of a structure of intermediate data that is transferred to a main memory from a preceding unit, according to Embodiment 3.

FIG. 11A is a flowchart of an example of processing in coding_{—}1 according to Embodiment 3.

FIG. 11B is a flowchart of an example of processing in coding_{—}2 according to Embodiment 3.

FIG. 12 is a block diagram schematically showing a configuration where an image coding apparatus includes two memories for saving intermediate data.

FIG. 13 is a block diagram schematically showing a configuration where a stream generation apparatus is connected to a first main memory and a second main memory.

### DESCRIPTION OF EMBODIMENTS

(Underlying Knowledge Forming Basis of the Present Invention)

In relation to the technique for efficiently generating a stream having high tolerance to transmission errors, the inventors have found the following problem:

In recent years, general television (TV) terminals have also been increasingly becoming compatible with networks. As a result, in particular, system large scale integrations (LSIs) for consumer appliances are demanded to be compatible with various types of coding schemes, such as free codecs whose coding and decoding algorithms are openly available.

However, some disadvantages occur when, for example, it is assumed that a new type of codec is executed with a hardware configuration that complies with conventional coding schemes (for example, H.264 coding scheme) which perform arithmetic coding.

For example, when a stream including moving picture data is transmitted via a network, it is necessary to generate a stream with high tolerance to transmission errors. As a technique for generating such a stream, there is a coding scheme which involves data partitioning.

In data partitioning, image coding information is divided into partitions. The partitions are classified into important information and unimportant information. The partitions where important information is stored are made to prevent the information from going missing.

In the stream obtained by such data partitioning, for example, headers including information such as a coding scheme or the like are concentrated in the beginning portion of the stream, followed by quantized data which has been coded.

However, at present, it is difficult to generate such a stream by a coding scheme which involves arithmetic coding.

For example, in a case where various types of headers are coded first so that the headers are concentrated at the beginning portion of a stream, it is necessary to decode each coded header to identify the probability table to be used for arithmetic coding of quantized data.

More specifically, in a case where a stream generation apparatus adopting a coding scheme with high compression rate, such as arithmetic coding, generates a stream on which data partitioning has been performed, it is necessary to perform inefficient processing which significantly decreases processing efficiency.

As a result, such a stream generation apparatus has problems of increase in processing time, required increase in processing capability, or increase in power consumption.

In order to solve the conventional problems, the stream generation apparatus according to one aspect of the present invention is a stream generation apparatus which generates a stream by performing variable-length coding and compression coding on input data including quantized data which is quantized image data and a header corresponding to the quantized data. The stream generation apparatus includes: an inserting unit which inserts, into the header, coding-related information which is information for identifying a position of necessary information in the header, the necessary information being information necessary for the compression coding of the quantized data; a first coding unit which performs first processing on the input data in a state before or after the insertion of the coding-related information, the first processing including the variable-length coding and the compression coding of the header; a first transfer control unit which transfers intermediate data to a storage unit connected to the stream generation apparatus, the intermediate data being the input data which includes the coding-related information and on which the first processing has been performed; a second transfer control unit which reads the intermediate data from the storage unit; an extracting unit which extracts the necessary information from the position in the header indicated by the coding-related information, the header being included in the read intermediate data; and a second coding unit which generates the stream by performing second processing including the compression coding of the quantized data which is included in the read intermediate data and on which the first processing has been performed, the compression coding being performed using the necessary information extracted by the extracting unit.

Furthermore, the stream generation apparatus according to one aspect of the present invention is a stream generation apparatus which generates a stream by performing variable-length coding and compression coding on input data including quantized data which is quantized image data and a header corresponding to the quantized data. The stream generation apparatus includes: an inserting unit which obtains coding-related information from the header and insert the obtained coding-related information into the input data, the coding-related information being necessary information for the compression coding of the quantized data; a first coding unit which performs first processing on the input data in a state before or after the insertion of the coding-related information, the first processing including the variable-length coding and the compression coding of the header; a first transfer control unit which transfers intermediate data to a storage unit connected to the stream generation apparatus, the intermediate data being the input data which includes the coding-related information and on which the first processing has been performed; a second transfer control unit which reads the intermediate data from the storage unit; an extracting unit which extracts the coding-related information from the read intermediate data; and a second coding unit which generates the stream by performing second processing including the compression coding of the quantized data which is included in the read intermediate data and on which the first processing has been performed, the compression coding being performed using the coding-related information extracted by the extracting unit.

According to the stream generation apparatuses, intermediate data is generated in the preceding processing. The intermediate data refers to input data on which the first processing has been performed and which includes coding-related information to be used for compression coding of quantized data.

More specifically, the coding-related information refers to information necessary for the compression coding of the quantized data or information for identifying the position of the necessary information in a header.

The generated intermediate data is temporarily stored in a storage unit and is read for the subsequent processing. As a result, the extracting unit is capable of easily extracting information necessary for compression coding of quantized data, from the intermediate data read from the storage unit, without decoding the entire header. More specifically, efficient compression coding can be performed on quantized data, with use of coding-related information.

In other words, even in a case where a coding scheme with high compression rate, such as arithmetic coding, is used as compression coding, it is possible to generate a stream on which data partitioning has been performed, for example, without decoding entire coded headers unlike the conventional scheme.

Furthermore, for example, it may be that the inserting unit inserts, as the coding-related information, a flag before the necessary information and a flag after the necessary information, the two flags being information for identifying the position of the necessary information in the header, and that the extracting unit extracts the necessary information located between the two flags.

Furthermore, for example, it may be that the inserting unit inserts a flag before the necessary information, as the coding-related information, the flag being information for identifying the position of the necessary information in the header, the flag indicating a starting position and a size of the necessary information, and that the extracting unit is configured to extract the necessary information, based on the starting position and the size indicated by the flag.

Furthermore, for example, it may be that the inserting unit inserts the coding-related information immediately after non-compressed data in the input data, and that the extracting unit extracts the coding-related information inserted immediately after the non-compressed data.

Furthermore, for example, it may be that the inserting unit inserts the coding-related information into the quantized data, and that the extracting unit extracts the coding-related information from the quantized data in the intermediate data.

Furthermore, for example, it may be that the inserting unit inserts the coding-related information into the quantized data by replacing high-frequency component data included in the quantized data with the necessary information.

Furthermore, for example, it may be that the first transfer control unit transfers the intermediate data to the storage unit (i) to store, in a first memory included in the storage unit, the header which is included in the intermediate data and on which the first processing has been performed, and (ii) to store, in a second memory included in the storage unit, the quantized data which is included in the intermediate data and on which the first processing has been performed, the second memory being physically different from the first memory.

Furthermore, for example, it may be that the first coding unit performs the first processing including (i) the variable length coding and the compression coding of the header and (ii) inputting of the quantized data to the first transfer control unit, and that the second coding unit performs the second processing including the variable-length coding and the compression coding of the quantized data which is included in the read intermediate data and on which the first processing has been performed.

Furthermore, for example, it may be that the first coding unit performs the first processing including (i) the variable length coding and the compression coding of the header and (ii) the variable length coding of the quantized data.

Furthermore, the present invention may also be implemented as an image coding apparatus which includes the stream generation apparatus according to any one of the above aspects.

Furthermore, the present invention may also be implemented as a stream generation method which includes characteristics processing executed by the stream generation apparatus according to any one of the above aspects. Furthermore, the present invention may also be implemented as a program causing a computer to execute each processing included in the stream generation method, and as a recording medium on which the program is recorded. The program may be distributed via a transmission medium, such as the Internet, or a recording medium, such as a DVD.

The present invention may also be implemented as an integrated circuit which includes part or all of the configuration of the stream generation apparatus according to any one of the aspects.

These general and specific aspects may be implemented using a system, a method, an integrated circuit, a computer program, or a recording medium, or any combination of systems, methods, integrated circuits, computer programs, or recording media.

Hereinafter, a description is given of embodiments of the present invention, referring to the drawings. Note that, the diagrams are schematic diagrams, and the illustration is not always strictly accurate.

Each of the exemplary embodiments described below shows a specific example. The numerical values, shapes, materials, structural elements, the arrangement and connection of the structural elements, steps, the processing order of the steps etc. shown in the following exemplary embodiments are mere examples, and therefore do not limit the present invention. Therefore, among the structural elements in the following exemplary embodiments, structural elements not recited in any one of the independent claims are described as arbitrary structural elements.

### Embodiment 1

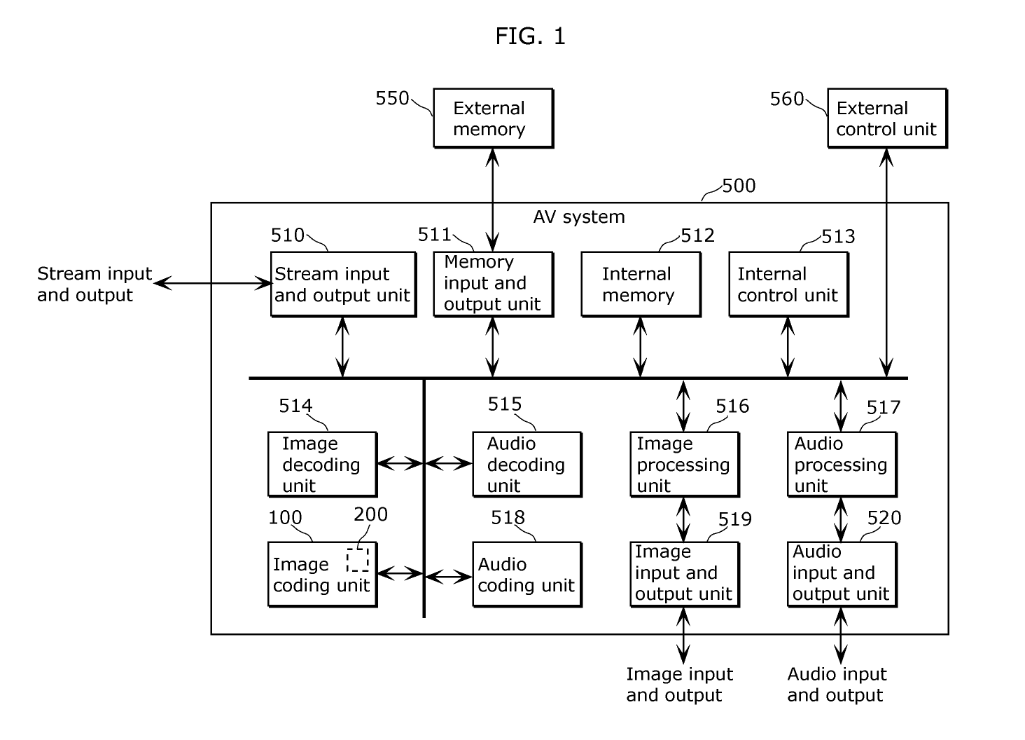

FIG. 1 is a diagram showing an example of a configuration of an audio and visual (AV) system 500 which includes an image coding unit 100 according to Embodiment 1.

The AV system 500 includes a stream input and output unit 510, a memory input and output unit 511, an internal memory 512, an internal control unit 513, an image decoding unit 514, an audio decoding unit 515, an image processing unit 516, an audio processing unit 517, an audio coding unit 518, an image input and output unit 519, an audio input and output unit 520, and the image coding unit 100.

The AV system 500 is connected to an external memory 550, and is capable of transmitting and receiving data to and from the external memory 550. The AV system 500 is also capable of operating according to a control signal from an external control unit 560.

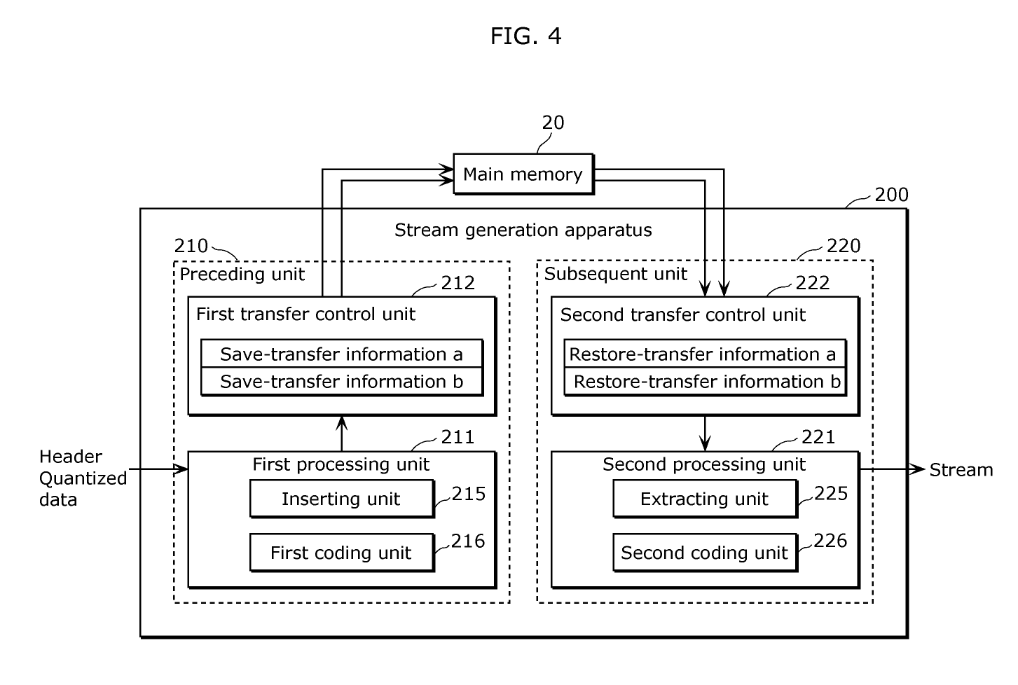

The image coding unit 100 includes a stream generation apparatus 200 which codes input data to generate a stream indicating moving pictures. A configuration of the stream generation apparatus 200 will be given later, referring to FIG. 4.

The image coding unit 100 is connected to other functional blocks via a bus to allow transmission and receipt of data, control signals and others. The stream generation apparatus 200 generates intermediate data in the process of generation of a stream, and uses the external memory 550 and the internal memory 512 for saving the intermediate data.

The external control unit 560 or the internal control unit 513 may directly control operations of the stream generation apparatus 200.

With such a configuration, in the AV system 500, the image coding unit 100 which includes the stream generation apparatus 200 is capable of generating a stream on which arithmetic coding and data partitioning have been performed, with use of image data input from the image input and output unit 519, for example. The generated stream is output from the stream input and output unit 510, and is received by an external playback apparatus via the Internet, for example.

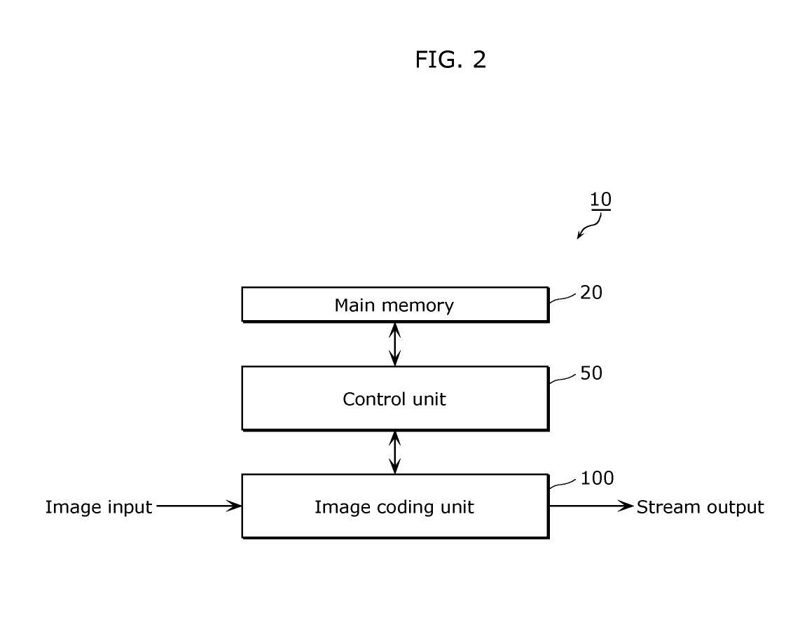

FIG. 2 is a block diagram schematically showing a configuration of the image coding apparatus 10 according to Embodiment 1.

As shown in FIG. 2, the image coding apparatus 10 includes an image coding unit 100, a control unit 50 and a main memory 20.

The main memory 20 is a memory for storing data (for example, dynamic random access memory (DRAM)).

The control unit 50 includes a processor (not shown), such as a central processing unit (CPU), and a memory control circuit (not shown).

In the image coding apparatus 10, the image coding unit 100 generates, relative to an input image, compressed data generated while saving and restoring intermediate data via the control unit 50, using the main memory 20 provided outside the image coding unit 100. The image coding unit 100 further outputs the compressed data as a stream.

More specifically, in a case where the image coding unit 100 is included in the AV system 500, at least one of the internal memory 512 and the external memory 550 functions as the main memory 20.

The control unit 50 controls not only transfer of data between the image coding unit 100 and the main memory 20, but also controls the image coding unit 100.

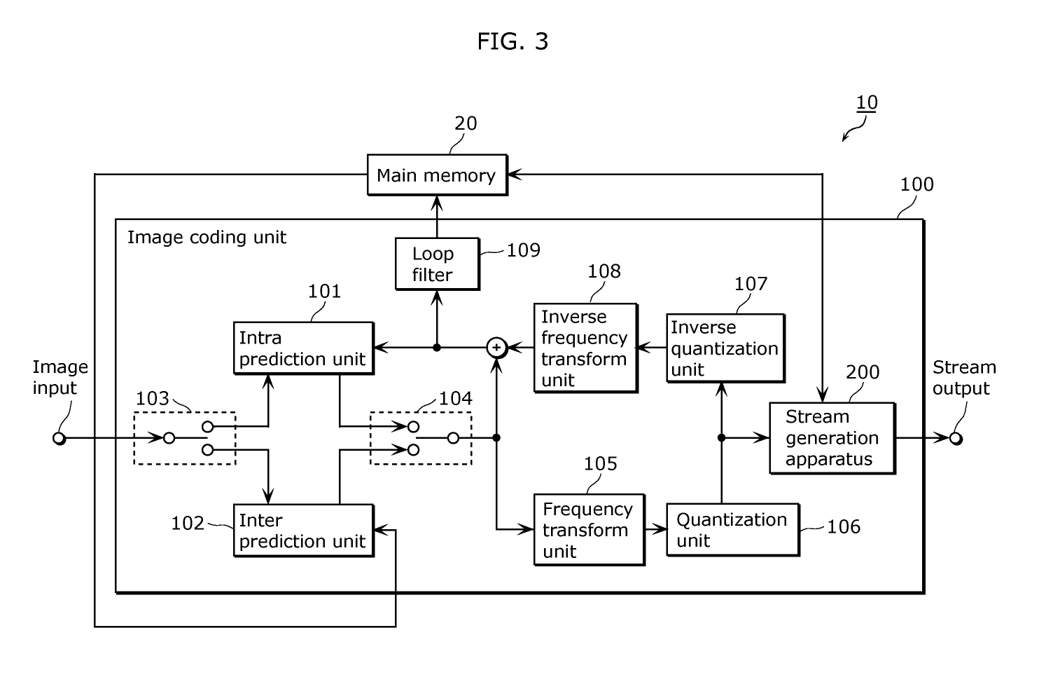

FIG. 3 is a block diagram schematically showing a configuration of the image coding unit 100 according to Embodiment 1.

Referring to FIG. 3, a description is given of basic processing performed by the image coding unit 100. The control unit 50 shown in FIG. 2 is not shown in FIG. 3.

An image input to the image coding unit 100 is input to an intra prediction unit 101 and an inter prediction unit 102, via a switch 103. The intra prediction unit 101 removes redundant information by prediction using spatial correlation within a picture. The inter prediction unit 102 removes redundant information by prediction using temporal correlation between pictures.

A switch 104 selects one of the intra prediction unit 101 and the inter prediction unit 102 according to the type of a picture to be coded, or which one of the intra prediction and the inter prediction is suitable for coding the picture. Accordingly, difference data which is data of a difference image between the input image and a prediction image is input to a frequency transform unit 105.

The difference data input to the frequency transform unit 105 is transformed into two-dimensional frequency component information by, for example, discrete cosine transform (DCT). The DCT coefficient data obtained by the transform is compressed by a quantization unit 106 making all of high-frequency component data that has less influences on human vision “0”.

The data which is provided by the quantization unit 106 and in which low-frequency components are relatively concentrated (hereinafter, referred to as quantized data) is further compressed in the stream generation apparatus 200 by variable-length coding, arithmetic coding, and others in the zigzag order in which the data is scanned, for example. In the stream generation apparatus 200, initial information (hereinafter, referred to as “header”) indicating coding information, such as a coding type, is further added to the compressed data, and the data is output as a stream.

Furthermore, the quantized data is input to an inverse quantization unit 107 to be restored to information approximating to the state before the quantization. Subsequently, an inverse frequency transform unit 108 restores the data to the original difference image data or data approximating the original difference image data.

The restored data and prediction image data corresponding to the restored data are combined to generate a reconstructed image. The generated reconstructed image or the reconstructed image on which deblocking has been applied by a loop filter 109 is saved in the main memory 20, and the image is read from the main memory 20 when inter prediction is performed.

The frequency transform unit 105 and the inverse frequency transform unit 108 may use a method other than DCT, as a frequency transform method. Furthermore, the scanning order in the stream generation apparatus 200 may be other than zigzag order. Furthermore, the method of compression coding in the stream generation apparatus 200 may be other than variable-length coding and arithmetic coding.

FIG. 4 is a block diagram schematically showing a configuration of the stream generation apparatus 200 according to Embodiment 1.

The stream generation apparatus 200 includes a preceding unit 210 and a subsequent unit 220. Each of the preceding unit 210 and the subsequent unit 220 is capable of communicating with the main memory 20 which is an example of a storage unit and which is connected to the stream generation apparatus 200.

The stream generation apparatus 200 generates a stream by performing variable-length coding and compression coding on input data which includes the quantized data input from the quantization unit 160 and headers indicating information necessary for decoding images, and outputs the stream

In Embodiment 1, binarization is performed as variable-length coding, and arithmetic coding is performed as compression coding.

Arithmetic coding is performed on a per-slice basis or on a per-picture basis, for example, that is a unit larger than a macroblock.

The preceding unit 210 includes a first processing unit 211 and a first transfer control unit 212. The first processing unit 211 includes an inserting unit 215 and a first coding unit 216.

The inserting unit 215 inserts, into input data, coding-related information that is information obtained from information included in input headers and to be used for compression coding of quantized data.

In Embodiment 1, as the coding-related information that is information to be used for compression coding of quantized data, flags are inserted into headers. The flags are an example of information for identifying the position, in the header, of the information necessary for compression coding.

Each flag is expressed by, for example, a unique data string that does not usually exist in an arithmetic coded data string. More specifically, the flag refers to, for example, a data string in which at least a predetermined number of a value of “0” or “1” is consecutive.

Here, the term “information necessary for compression coding of quantized data” refers to, for example, information for identifying the probability table to be referred to when performing arithmetic coding on the quantized data. In Embodiment 1 and other embodiments, the information is referred to as “probability information”. Examples of the probability information include random variables corresponding to the quantized data.

Furthermore, another example of “the information necessary for compression coding of quantized data” is coding-skip-information. The coding-skip-information refers to information which indicates that compression coding of quantized data is to be skipped when all of the coefficient values in the quantized data are “0”, for example.

The first coding unit 216 performs first processing on the input data in a state before or after the insertion of the coding-related information. The first processing includes variable-length coding and compression coding of headers.

In Embodiment 1, as the first processing, binarization and arithmetic coding are performed on headers into which flags have been inserted, and quantized data is input to the first transfer control unit 212.

No binarization and arithmetic coding are performed on the flags inserted into the headers. Hence, the subsequent unit 220 is capable of easily detecting the flags from the arithmetic coded headers.

The first transfer control unit 212 transfers, to the main memory 20, intermediate data which includes flags and which is input data on which the first processing has been performed. More specifically, the headers, included in the intermediate data and on which processing up to and including arithmetic coding has been performed, and the quantized data, included in the intermediate date and on which no processing has been performed after input, are stored in different storage areas in the main memory 20.

More specifically, the first transfer control unit 212 saves, in different storage areas in the main memory 20, the headers and the quantized data which are included in the intermediate data and on which the first processing has been performed.

The first transfer control unit 212 holds at least two types of transfer-control information for controlling such save processing, and refers to the transfer-control information when performing the save processing (transfer processing).

More specifically, the first transfer control unit 212 holds save-transfer information a corresponding to the storage area for headers and save-transfer information b corresponding to the storage area for quantized data.

The subsequent unit 220 includes a second processing unit 221 and a second transfer control unit 222. The second processing unit 221 includes an extracting unit 225 and a second coding unit 226.

The second transfer control unit 222 reads intermediate data from the main memory 20, and transfers the intermediate data to the second processing unit 221.

More specifically, the second transfer control unit 222 reads, from the main memory 20, the headers on which processing up to and including arithmetic coding has been performed, and transfers the headers to the second processing unit 221. The second transfer control unit 222 further reads, from the main memory 20, the quantized data on which binarization and arithmetic coding have not been performed, and transfers the quantized data to the second processing unit 221.

The extracting unit 225 in the second processing unit 221 extracts, from the intermediate data read by the second transfer control unit 222, information indicated by the coding-related information.

In Embodiment 1, the extracting unit 225 detects a flag (start flag) that is coding-related information included in an arithmetic coded header in the intermediate data, and extracts probability information located between the start flag and a next flag (end flag). More specifically, the probability information read from between the start flag and the end flag is decoded, and is used for arithmetic coding performed by the second coding unit 226.

The second coding unit 226 generates a stream by performing second processing including compression coding of the quantized data which is included in the read intermediate data and on which the first processing has been performed. The compression coding is performed using information extracted by the extracting unit 225.

In Embodiment 1, binarization and arithmetic coding are not performed on the quantized data in the first processing, but are performed on the quantized data by the second coding unit 226.

The probability table referred to when arithmetic coding is performed by the second coding unit 226 is identified by the probability information extracted by the extracting unit 225. Furthermore, the probability table is updated based on the probability information as necessary.

The second processing unit 226 further generates a stream including first coded data followed by second coded data which are obtained by the first processing and the second processing.

The first coded data refers to data that is headers which are for a predetermined unit and on which variable-length coding and compression coding have been performed. The second coded data refers to data that is quantized data items which are for the predetermined unit and on which variable-length coding and compression coding have been performed.

More specifically, in Embodiment 1, as described above, the headers and quantized data, which are included in the intermediate data and on which the first processing has been performed, are stored in different storage areas in the main memory 20.

The second transfer control unit 222 reads headers for a predetermined unit on which the first processing has been performed, and quantized data for the predetermined unit on which the first processing has been performed, from corresponding storage areas. More specifically, the intermediate data saved in the main memory 20 is restored by the second transfer control unit 222.

In such a manner, the headers for the predetermined unit, which are obtained by the second transfer control unit 222 and on which the first processing has been performed, that is, the headers for the predetermined unit, on which processing up to and including arithmetic coding has been performed, are transmitted to the second processing unit 221 for extraction of the probability information.

The quantized data for the predetermined unit, which are read by the second transfer control unit 222 and on which the first processing has been performed, that is, the quantized data for the predetermined unit, on which binarization and arithmetic coding have not been performed, are transmitted to the second processing unit 221 for binarization and arithmetic coding.

The headers for the predetermined unit on which processing up to and including arithmetic coding has been performed (first coded data) and the quantized data for the predetermined unit on which processing up to and including arithmetic coding has been performed (second coded data) are connected and output from the second processing unit 221 as a stream.

The start flag and the end flag are unnecessary for decoding the stream; and thus, for example, the second coding unit 226 deletes the flags when generating the stream.

The second transfer control unit 222 holds at least two types of transfer-control information for controlling the restore processing of the headers and quantized data, and refers to the transfer-control information when performing the restore processing (transfer processing)

More specifically, the second transfer control unit 222 holds restore-transfer information a corresponding to the storage area where headers are stored and restore-transfer information b corresponding to the storage area where quantized data is stored.

With such a configuration, the stream generation apparatus 200 achieves generation of a stream to which both data partitioning and arithmetic coding have been applied.

The first processing unit 211 in the preceding unit 210 inserts, into a header, flags for identifying the position of the probability information included in the header. With this, the second processing unit 221 in the subsequent unit 220 is capable of easily recognizing the position of the probability information in the header. As a result, the second processing unit 221 is capable of decoding only the probability information without decoding the entire header, and using the probability information for arithmetic coding of quantized data.

In Embodiment 1, each of the first processing unit 211 and the second processing unit 221 performs processing including binarization and arithmetic coding. As the area for saving binary data generated in the above processing, for example, a predetermined storage area in the main memory 20 or a storage area within the stream generation apparatus 200 (not shown) is used.

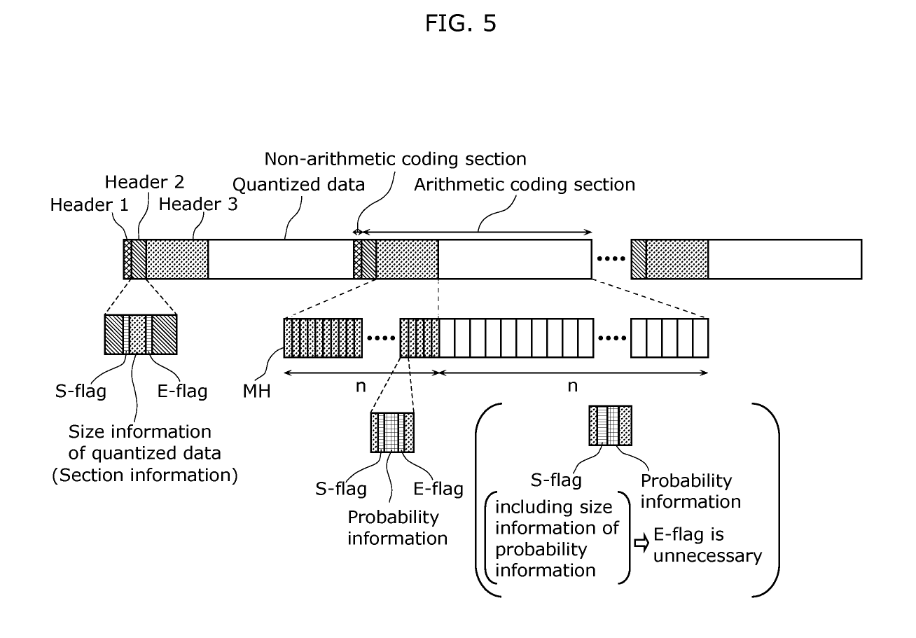

FIG. 5 is a diagram showing an example of a structure of intermediate data that is transferred to the main memory 20 from the preceding unit 210, according to Embodiment 1.

As shown in FIG. 5, the intermediate data in Embodiment 1 includes headers and quantized data.

More specifically, the intermediate data includes three types of headers that are header 1, header 2, and header 3.

The header 1 is included in a non-arithmetic coding section, and includes, for example, frame information, version information, a stream start code, and angle-of-view information.

The header 2 is, for example, a frame header, and includes size information (hereinafter, referred to as “section information”) indicating the size of quantized data in units of macroblock. More specifically, the header 2 also includes, for example, correction information, filter information, and Boolean probability information necessary for decoding arithmetic coded frame information.

The header 3 consists of, for example, macroblock headers for a predetermined unit (for example, n macroblock headers for one picture). The macroblock header is referred to as “MH” in FIG. 5. Each macroblock header includes probability information necessary for arithmetic coding of corresponding quantized data. Examples of the predetermined unit include a picture or a slice.

In FIG. 5, the quantized data that is located immediately after the header 3 is the quantized data corresponding to the header 3. More specifically, the data portion that is immediately after the header 3 includes a sequence of quantized data for macroblocks for the predetermined unit.

The quantized data is included in an arithmetic coding section. Binarization and arithmetic coding are performed on the quantized data by the second processing unit 221 after the intermediate data is obtained by the subsequent unit 220 as described above. Hence, at the time when the intermediate data is transferred from the preceding unit 210 to the main memory 20, the quantized data is in a state before binarization and arithmetic coding are performed.

The second processing unit 221 in the subsequent unit 220 is capable of dividing the quantized data for a predetermined unit included in the intermediate data, into quantized data for each macroblock, by referring to the section information included in the header 2.

The intermediate data in Embodiment 1 includes flags, inserted by the inserting unit 215, before and after the probability information and section information.

More specifically, a start flag (S-flag) is inserted before the probability information and the section information, and an end flag (E-flag) is inserted after the probability information and the section information.

These flags are unique data strings as described above, and are skipped when the first coding unit 216 performs binarization and arithmetic coding on the header 2 and the header 3. In other words, the flags remain in the intermediate data as being unique data strings.

Hence, the second processing unit 221 in the subsequent unit 220 is capable of easily detecting the S-flag and the E-flag. More specifically, the second processing unit 221 is capable of easily extracting probability information or section information located between the S-flag and the E-flag.

More specifically, the extracting unit 225 in the second processing unit 221 reads, from a header, data which is from immediately after the S-flag and to the E-flag, and decodes only the read data. With this, the probability information or the section information located between the S-flag and the E-flag is extracted.

Instead of identifying the position of the probability information by a pair of the S-flag and the E-flag, it may be that the S-flag includes size information indicating the size of the probability information, as shown in the lower right in FIG. 5, for example. In this case, too, the subsequent unit 220 is capable of easily obtaining the probability information.

More specifically, the E-flag is unnecessary in this case. The extracting unit 225 is capable of extracting the probability information based on the starting position of the probability information (for example, the position immediately after the S-flag) and the size information indicated by the S-flag.

With respect to the section information, it may also be that the position of the section information is identified by including the size information indicating the size of the section information in the S-flag which indicates the starting position, in the similar manner.

Furthermore, in the case where the probability information or the like is located immediately after the E-flag, the E-flag is also processed as information indicating the starting position of the probability information or the like. More specifically, in the case where multiple kinds of information necessary for arithmetic coding of quantized data are successive, each E-flag located between the multiple kinds of information is processed not only as information indicating the end position of information located immediately before the E-flag, but also as information indicating the starting position of the information located immediately after the E-flag.

It may also be that a pair of S-flag and E-flag may be inserted into a given header such that multiple kinds of information which is successive in the header are sandwiched between the pair of S-flag and the E-flag.

In any cases, the subsequent unit 220 is capable of easily obtaining information necessary for arithmetic coding of the quantized data, by detecting the S-flag, or the S-flag and the E-flag.

Furthermore, FIG. 5 schematically shows a structure of intermediate data transferred from the preceding unit 210 to the main memory 20. In FIG. 5, headers (the headers 1 to 3) and quantized data are successive. However, in the main memory 20, as described above, the headers (the headers 1 to 3) and the quantized data are stored in different storage areas.

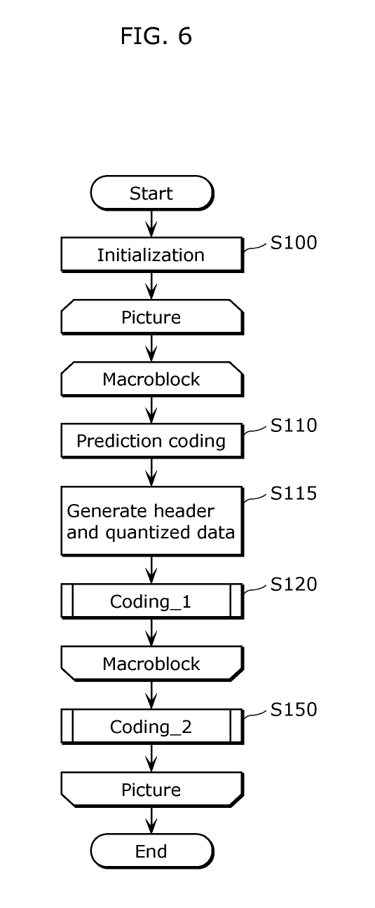

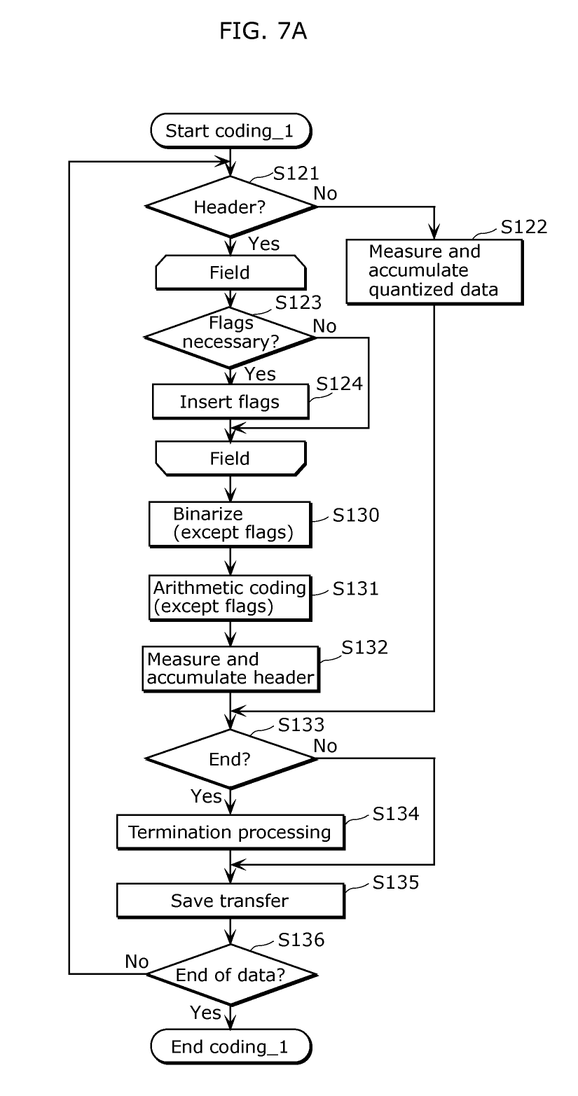

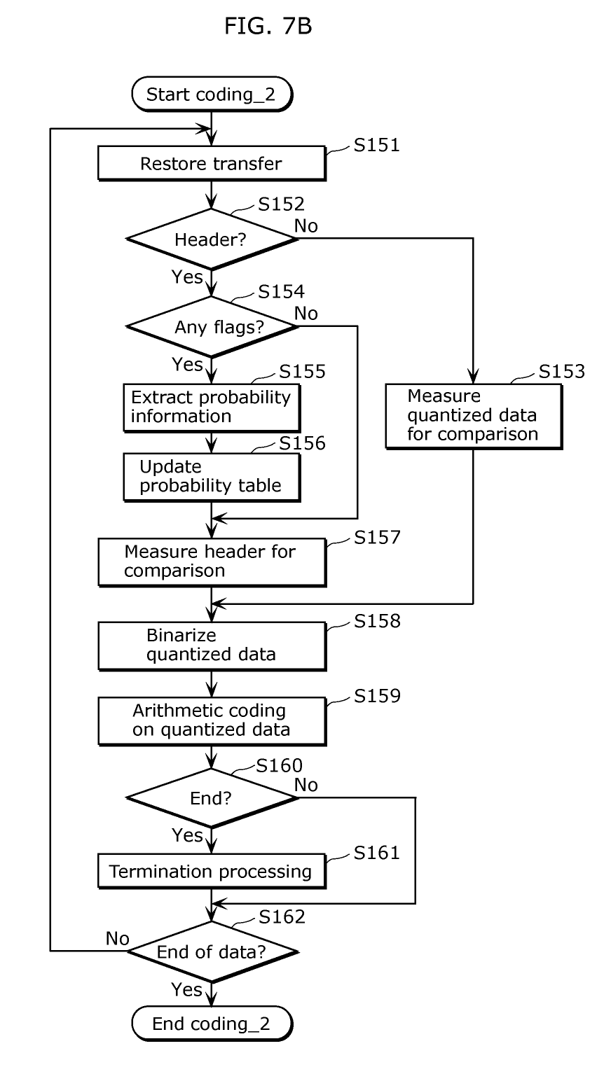

Referring to the flowcharts in FIG. 6 to FIG. 7B, a description is given of the flow of processing performed by the image coding unit 100 which includes the stream generation apparatus 200 according to Embodiment 1.

FIG. 6 is a flowchart of an example of processing performed by the image coding unit 100 according to Embodiment 1.

First, an image size, a frame rate, a bit rate and others serving as parameters used for image coding are preset (S100). After the preset, image data is input to the image coding unit 100.

The input image data (input data) is repeatedly processed on a per-predetermined unit basis, such as a picture. For example, coding is performed on a per-block basis, such as a macroblock, and the intermediate data generated by the coding is transformed into stream data.

For example, the intra prediction and the inter prediction described above are performed on a per-macroblock basis (S110). Furthermore, quantized data is generated by frequency transform and quantization, and a header necessary for decoding is generated (S115).

The header and the quantized data thus generated are input to the stream generation apparatus 200, and coding_{—}1 is performed on the header and the quantized data (S120). In the coding_{—}1, the first processing unit 211 performs first processing on the header and the quantized data. The first transfer control unit 212 transfers, to the main memory 20, the intermediate data obtained by the first processing and including coding-related information.

For example, when the coding_{—}1 (S120) is completed for all the macroblocks in one picture, the stream generation apparatus 200 performs coding_{—}2 (S150).

In the coding_{—}2, the second transfer control unit 222 reads the intermediate data for the one picture (the headers and quantized data on which the first processing has been performed), and the second processing unit 221 performs the second processing on the intermediate data for the one picture.

As a result, the stream generation apparatus 200 outputs a stream in which various kinds of headers are concentrated in a predetermined portion, that is, a stream on which data partitioning has been performed.

FIG. 7A is a flowchart of an example of processing in the coding_{—}1 shown in FIG. 6.

The first processing unit 211 in the preceding unit 210 determines whether or not the input data to be processed is a header (S121). When the input data is not a header (No in S121), that is, when the input data is quantized data, the coding amount of the quantized data is measured, and the measurement result is accumulated (S122). In Embodiment 1, the quantized data is input to the first transfer control unit 212 without being coded by the first coding unit 216.

When the input data to be processed is a header (Yes in S121), the inserting unit 215 inserts flags into the header (S123 and S124).

More specifically, it is determined whether or not flags need to be inserted into each data field of the header (S123). In other words, when the data field for which the determination is made includes information necessary for arithmetic coding of quantized data, such as probability information, it is determined that the flag insertion is necessary (Yes in S123). As a result, the inserting unit 215 inserts flags (S-flag and E-flag) before and after the data field (S124).

Here, as described with reference to FIG. 5, it may be that the inserting unit 215 inserts, before the data field, the S-flag including information indicating the size of the data field, and omits insertion of the E-flag.

After the flags are inserted into the header (S123 and S124), the first coding unit 216 performs binarization on the header (S130), and arithmetic coding on the header (S131). In the binarization and the arithmetic coding, as described above, the flags inserted into the header are skipped.

More specifically, since the flags are unique data strings, the first coding unit 216 is capable of easily determining whether the data to be processed is a flag or not. When the data to be processed is a flag, the first coding unit 216 outputs the data without performing binarization and arithmetic coding. Hence, the flags remain in a state of unique data strings that are easily detectable by the subsequent unit 220.

The flag insertion (S124), binarization (S130) and arithmetic coding (S131) may be performed in a different order. For example, the inserting unit 215 first identifies the positions of the flags inserted into a given header, and then the first coding unit 216 performs binarization on the header. Subsequently, the inserting unit 215 calculates the positions into which flags are to be inserted, based on the identified positions and the amount of variation in the data length caused due to binarization, and inserts flags into the calculated positions. Furthermore, the first coding unit 216 performs arithmetic coding on portions other than the flags of the header.

Such a configuration also allows flags which are coding-related information to be appropriately inserted into a header, and allows arithmetic coding to be appropriately performed on the header.

Subsequently, the coding amount of the header on which processing up to and including arithmetic coding has been performed is measured and accumulated (S132).

When the end of a header or the end of quantized data for a macroblock is to be processed (Yes in S133), the first transfer control unit 212 performs termination processing on the end for connecting to a subsequent header or subsequent quantized data (S134).

The first transfer control unit 212 further saves the thus obtained intermediate data in the main memory 20 according to the data format shown in FIG. 5 (S135). Here, the intermediate data refers to the binarized and arithmetic coded headers, or quantized data on which binarization and arithmetic coding have not been performed).

Subsequently, for example, when there is no more data to be transferred to the main memory 20 (Yes in S136), the coding_{—}1 ends.

FIG. 7B is a flowchart of an example of processing in coding_{—}2 shown in FIG. 6.

The second transfer control unit 222 in the subsequent unit 220 restores the intermediate data from the main memory 20 (S151). More specifically, the intermediate data is read from the main memory 20.

When the read intermediate data is not a header (No in S152), that is, when the second transfer control unit 222 reads quantized data, the second transfer control unit 222 measures the coding amount of the read data, and compares the measurement result and the total coding amount of the quantized data (S153). The comparison result is used when determining whether or not data to be processed is the end of a header or quantized data (S160). The quantized data is transmitted to the second processing unit 221.

When the second transfer control unit 222 reads a header as the intermediate data (Yes in S152), the header is transmitted to the second processing unit 221. The extracting unit 225 checks if the header includes any flags (S154).

When the header includes flags (Yes in S154), the extracting unit 225 extracts probability information located at the positions indicated by the flags (S155). In Embodiment 1, as described above, the extracting unit 225 reads the probability information located between the S-flag and the E-flag, and decodes the read probability information.

The flowchart shows an example of processing where probability information is extracted as information necessary for arithmetic coding of the quantized data. However, when the section information (see FIG. 5) is located between the S-flag and the E-flag, too, the extracting unit 225 reads the section information and decodes the section information in the similar manner.

The probability information and the section information thus extracted are transmitted to the second coding unit 226. The second coding unit 226 divides the quantized data received from the second transfer control unit 222 into macroblocks, using the received section information.

The second coding unit 226 also identifies, updates, and others the probability table to be used for arithmetic coding of quantized data corresponding to the probability information (S156), using the received probability information.

The correspondence between probability information items and quantized data items are defined by the alignment sequence (see FIG. 5) of the probability information and the quantized data in the intermediate data. For example, in FIG. 5, the probability information obtained from the k-th macroblock header from the left among n macroblock headers corresponds to the k-th quantized data from the left among n quantized data items that are in units of macroblocks.

Furthermore, the coding amount of the data to be processed is measured, and the measurement result is compared with the total coding amount of the headers (S157). The comparison result is used when determining whether or not data to be processed is the end of a header or quantized data (S160).

The second coding unit 226 performs binarization (S158) and arithmetic coding (S159) on quantized data for each macroblock (S159). In the arithmetic coding, the probability table that has been updated as necessary (S156) is referred to.

Furthermore, the second transfer control unit 222 performs termination processing (S161) when the second transfer control unit 222 detects that data to be processed is the end of a header or the end of quantized data (Yes in S160).

Subsequently, for example, when the data to be processed is the end of a picture (Yes in S162), the second coding unit 226 generates and outputs a stream in which arithmetic coded headers for one picture followed by arithmetic coded quantized data corresponding to the headers. When the data to be processed is not the end of a picture (No in S162), coding_{—}2 is performed again.

In such a manner, in the stream generation apparatus 200 according to Embodiment 1, the first processing unit 211 in the preceding unit 210 generates intermediate data with coding-related information (flags in Embodiment 1) that is information to be used for arithmetic coding of the quantized data inserted.

As a result, the extracting unit 225 in the subsequent unit 220 which has received such intermediate data is capable of decoding only necessary portion without decoding the entire header to which processing up to and including arithmetic coding has been performed. This allows information (such as probability information) necessary for arithmetic coding of the quantized data to be efficiently obtained.

More specifically, when headers are separated from quantized data corresponding to the headers and concentrated at the beginning portion of a stream, arithmetic coding is performed on the headers first prior to the quantized data. As a result, the arithmetic coded headers include information necessary for arithmetic coding of the quantized data.

In such a case, too, the preceding unit 210 in the stream generation apparatus 200 inserts, into an arithmetic coded header, flags for identifying the position of the necessary information in the header, allowing the subsequent unit 220 to efficiently perform arithmetic coding on the quantized data.

Here, it may be that the information necessary for arithmetic coding of the quantized data is obtained from a header in a state before arithmetic coding is performed, and the obtained information is transmitted from the preceding unit 210 to the subsequent unit 220 via a path different from the transmission path of the intermediate data.

However, in this case, an apparatus which performs arithmetic coding needs to include such a transmission path of the information, and a mechanism for synchronizing the quantized data and information necessary for arithmetic coding of the quantized data is also necessary. In other words, providing such a transmission path for the information is unlikely in practice, because, for example, it results in complicated configuration and control of the apparatus.

More specifically, the stream generation apparatus 200 according to Embodiment 1 efficiently generates a stream on which arithmetic coding and data partitioning have been performed, without providing a transmission path of information necessary for arithmetic coding of quantized data that is different from the transmission path of the intermediate data.

As described above, the stream generation apparatus 200 according to Embodiment 1 efficiently generates a stream having both high error tolerance and high compression rate.

### Embodiment 2

Next, as Embodiment 2, a description is given of a stream generation apparatus 200 which generates intermediate data having a data structure different from that in Embodiment 1.

The basic configuration of the stream generation apparatus 200 according to Embodiment 2 is the same as that of the stream generation apparatus 200 according to Embodiment 1 shown in FIG. 4, and the descriptions thereof are omitted here.

Furthermore, in the similar manner to the stream generation apparatus 200 according to Embodiment 1, the stream generation apparatus 200 according to Embodiment 2 is capable of functioning as an apparatus which is included in the image coding unit 100 (see FIG. 1 to FIG. 3), and which codes input image data and generates a stream.

Furthermore, the basic flow of the processing performed by the image coding unit 100 which includes the stream generation apparatus 200 according to Embodiment 2 is also the same as that shown in FIG. 6, and the descriptions thereof are omitted.

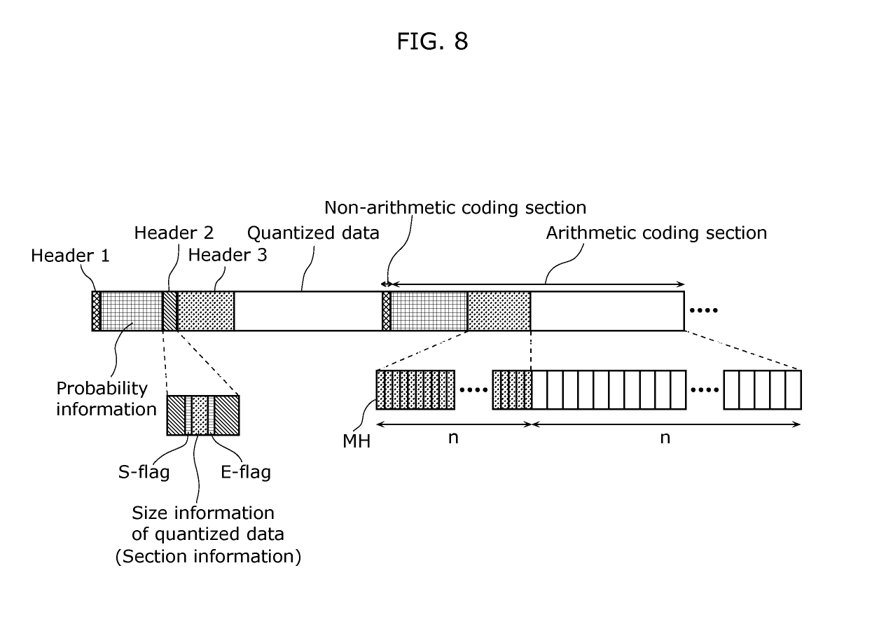

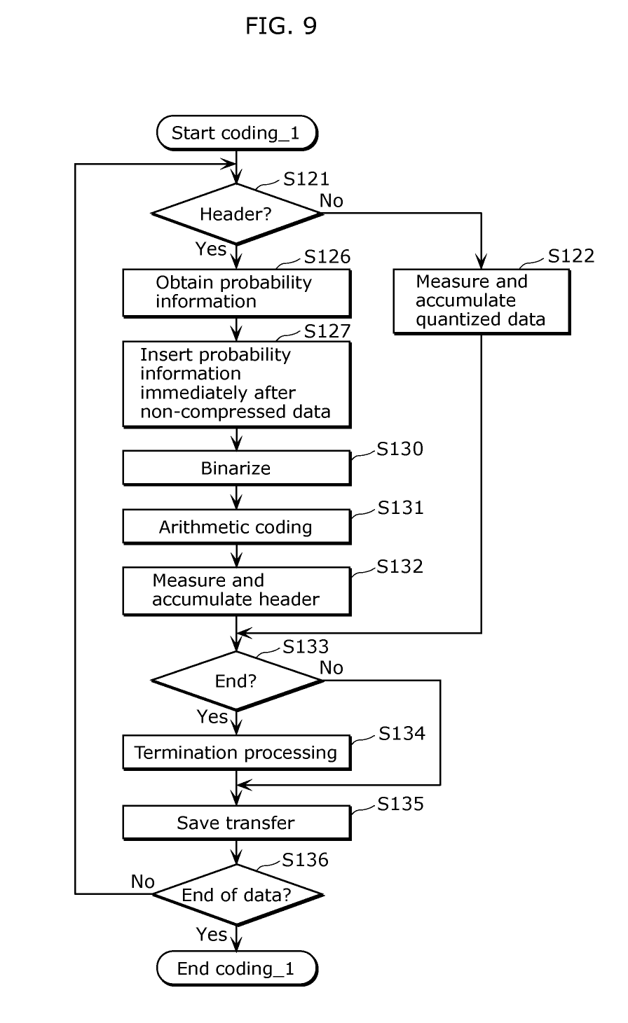

Hereinafter, referring to FIG. 8 and FIG. 9, a description is given of the characteristic processing performed by the stream generation apparatus according to Embodiment 2.

FIG. 8 is a diagram showing an example of a structure of intermediate data that is transferred to the main memory 20 from the preceding unit 210, according to Embodiment 2.

As shown in FIG. 8, the intermediate data according to Embodiment 2 includes headers and quantized data, in the similar manner to the intermediate data according to Embodiment 1. The intermediate data includes three types of headers that are header 1, header 2, and header 3.

However, each macroblock header includes no flag for identifying the position of the probability information. The probability information included in each macroblock header is also inserted immediately after the header 1 in the non-arithmetic coding section.

In other words, as in the case shown in FIG. 8, probability information is copied from each of n macroblock headers, and n pieces of copied probability information are inserted immediately after the header 1 that is non-compressed data, as coding-related information.

Accordingly, the extracting unit 225 in the subsequent unit 220 is capable of reading the probability information easily, and decoding the probability information. More specifically, the probability information is easily extracted.

The probability information inserted immediately after the header 1 is not required eventually in the stream. For example, the probability information is deleted eventually by the second coding unit 226.

Furthermore, for example, by making the probability information inserted immediately after the header 1 fixed length, the extracting unit 225 is capable of recognizing to which position decoding is to be performed from immediately after the header 1 that is non-compressed data.

Furthermore, for example, by also making the probability information inserted immediately after the header 1 non-compressed data (no arithmetic coding is performed), the extracting unit 225 is easily capable of extracting the probability information.

Furthermore, in FIG. 8, in the similar manner to Embodiment 1, the position of the section information in the header 2 is indicated by flags (S-flag, and E-flag). However, in the similar manner to the probability information, the section information may also be copied from the header 2 and is inserted between the header 1 and the probability information, for example.

Furthermore, in the similar manner to the intermediate data according to Embodiment 1, when the intermediate data according to Embodiment 2 is stored in the main memory 20, headers (including the headers 1 to 3 and the probability information immediately after the header 1) and quantized data are stored in different areas.

FIG. 9 is a flowchart of an example of processing in coding_{—}1 according to Embodiment 2.

Compared with the flow of coding_{—}1 according to Embodiment 1 shown in FIG. 7A, the flow shown in FIG. 9 is different only in S126 and S127; thus a description is given mainly on S126 and S127.

When the input data to be processed is a header (Yes in S121), in the first processing unit 211 in the preceding unit 210 according to Embodiment 2, the inserting unit 215 obtains probability information from the header (S126).

The inserting unit 215 inserts the probability information immediately after the non-compressed data (the header 1) that has already been received as input data prior to the header (S127).

The processing of S126 and S127 is performed every time a header including probability information is input to the inserting unit 215.

The section information is omitted in the flow of processing shown in FIG. 9. For example, in the similar manner to Embodiment 1, in the processing of inserting flags (S123 and S124 in FIG. 7A), flags (S-flag and E-flag) for identifying the position of the section information are inserted into the header 2.

Subsequently, binarization (S130) and others are performed on the header, and is stored in the main memory 20 in the data format shown in FIG. 8.

After that, coding_{—}2 is performed by the subsequent unit 220. More specifically, the second transfer control unit 222 reads the intermediate data from the main memory 20. The extracting unit 225 extracts, from the read intermediate data, the probability information located immediately after the non-compressed data (the header 1).

The extracted probability information is used for arithmetic coding of the quantized data performed by the second coding unit 226. As a result, in the similar manner to Embodiment 1, a stream is generated on which arithmetic coding and data partitioning have been performed.

In such a manner, in the stream generation apparatus 200 according to Embodiment 2, as in Embodiment 1, the first processing unit 211 in the preceding unit 210 generates intermediate data into which coding-related information that is information to be used for arithmetic coding of the quantized data is inserted.

In Embodiment 2, information necessary for arithmetic coding of quantized data, such as probability information, is inserted immediately after the non-compressed data (the head 1) as coding-related information.

As a result, the extracting unit 225 in the subsequent unit 220 which has received such intermediate data is capable of decoding only necessary portion without decoding the entire header to which processing up to and including arithmetic coding has been performed. This allows information (such as probability information) necessary for arithmetic coding of the quantized data to be efficiently obtained. As a result, it is possible to efficiently generate a stream on which arithmetic coding and data partitioning have been performed.

More specifically, the stream generation apparatus 200 according to Embodiment 2 efficiently generates a stream having both high error tolerance and high compression rate.

### Embodiment 3

Next, as Embodiment 3, a description is given of a stream generation apparatus 200 which generates intermediate data having a data structure different from those in Embodiment 1 and 2.

The basic configuration of the stream generation apparatus 200 according to Embodiment 3 is the same as that of the stream generation apparatus 200 according to Embodiment 1 shown in FIG. 4, and the descriptions thereof are omitted.

Furthermore, in the similar manner to the stream generation apparatus 200 according to Embodiment 1, the stream generation apparatus 200 according to Embodiment 3 is capable of functioning as an apparatus which is included in the image coding unit 100 (see FIG. 1 to FIG. 3), and which codes input image data and generates a stream.

Furthermore, the basic flow of the processing performed by the image coding unit 100 which includes the stream generation apparatus 200 according to Embodiment 3 is also the same as that shown in FIG. 6, and the descriptions thereof are omitted.

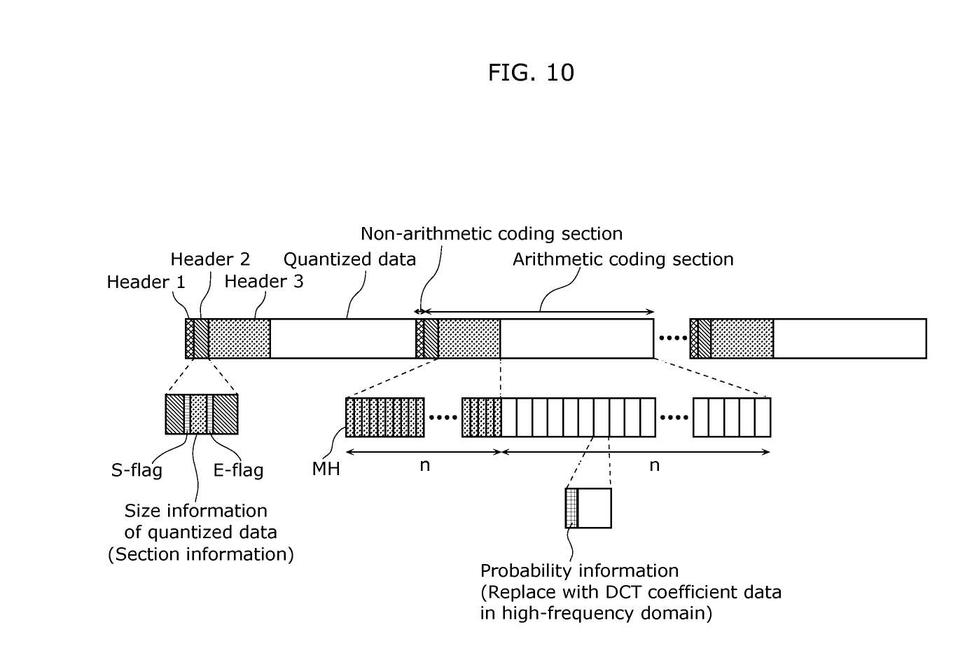

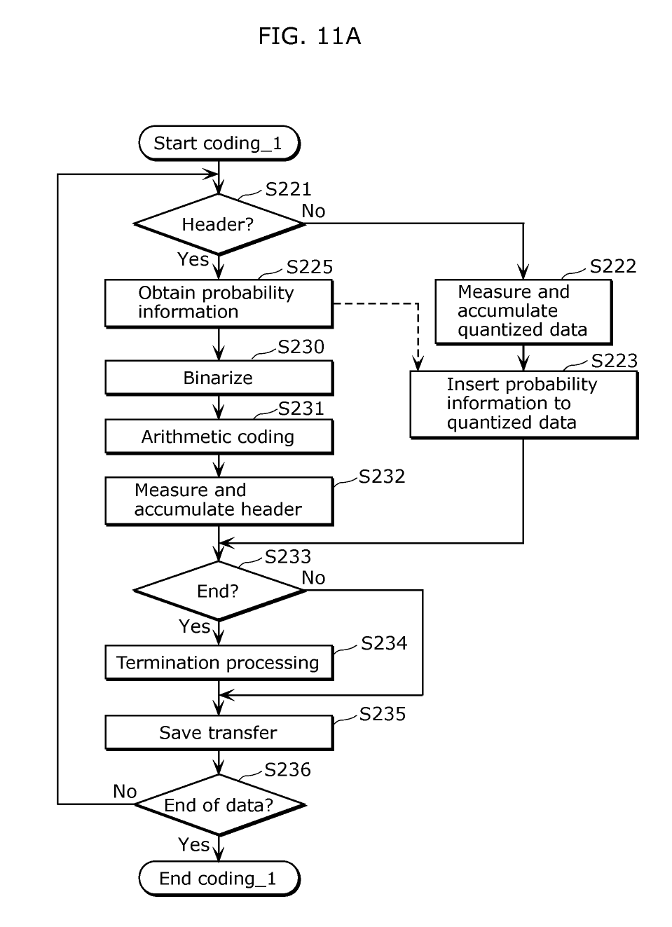

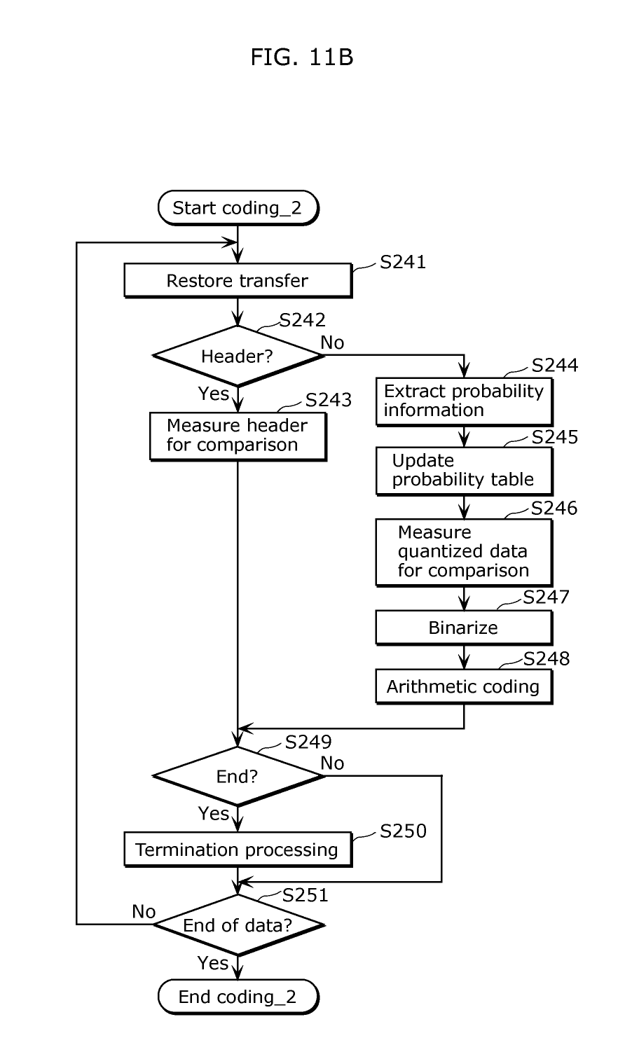

Hereinafter, referring to FIG. 10 to FIG. 11B, a description is given of the characteristic processing performed by the stream generation apparatus 200 according to Embodiment 3.

FIG. 10 is a diagram showing an example of a structure of intermediate data that is transferred to the main memory 20 from the preceding unit 210, according to Embodiment 3.

As shown in FIG. 10, the intermediate data according to Embodiment 3 includes headers and quantized data, in the similar manner to the intermediate data according to Embodiment 1. The intermediate data includes three types of headers that are header 1, header 2, and header 3.

However, flags for identifying the position of the probability information are not inserted into each macroblock header, but are inserted into the quantized data of each macroblock.

More specifically, the inserting unit 215 replaces quantized DCT coefficient data of high-frequency domain (high-frequency component data) included in the quantized data with the probability information corresponding to the quantized data. As a result, the probability information is inserted into the quantized data.

Furthermore, for example, the coding skip information may be replaced with the high-frequency component data as information necessary for compression coding of the quantized data.

Here, the high-frequency component data is likely to have consecutive 0 (zero) coefficient. Even if the entire data region of the high-frequency component data is replaced with 0 coefficient, extremely small impact is caused on the image quality recognized by human.

In view of this, the data region is used as a region into which information necessary for compression coding is embedded, and for example, in the final stage of generating a stream, the embedded probability information is replaced with 0 coefficient.

This restricts a decrease in processing efficiency of the intermediate data while maintaining the substantial image quality.

Since the quantized data is not coded by the preceding unit 210, the extracting unit 225 in the subsequent unit 220 is capable of easily extracting probability information from the quantized data of each macroblock.

The section information for obtaining the quantized data for each macroblock is, for example, identified by the S-flag and the E-flag inserted into the header 2, in the similar manner to Embodiment 1.

FIG. 11A is a flowchart of an example of processing in coding_{—}1 according to Embodiment 3.

The first processing unit 211 in the preceding unit 210 determines whether or not the input data to be processed is a header (S221). When the input data to be processed is a header (Yes in S221), the inserting unit 215 obtains probability information from the header (S225).

The obtained probability information items are stored in a predetermined storage area in the inserting unit 215 in the order in which the information is obtained, and sequentially read in the same order when being inserted into the quantized data (S223).

Subsequently, the first coding unit 216 binarizes the header (S230), and performs arithmetic coding on the header (S231). Subsequently, the coding amount of the header on which processing up to and including the arithmetic coding has been performed is measured and accumulated (S232).

When the input data is not a header (No in S221), that is, when the input data is quantized data, the coding amount of the quantized data is measured, and the measurement result is accumulated (S222).

The inserting unit 215 inserts (S223), into the quantized data, the probability information corresponding to the quantized data held after being obtained in S225.

Subsequently, when the end of a header or the end of quantized data for a macroblock is to be processed (Yes in S233), the first transfer control unit 212 performs termination processing on the end for connecting to a subsequent header or subsequent quantized data (S234).

The first transfer control unit 212 further saves the thus obtained intermediate data in the main memory 20 according to the data format shown in FIG. 10 (S235). Here, the intermediate data refers to the binarized and arithmetic coded headers, or quantized data on which binarization and arithmetic coding have not been performed).

Subsequently, for example, when there is no more data to be transferred to the main memory 20 (Yes in S236), coding_{—}1 ends.

FIG. 11B is a flowchart of an example of processing in coding_{—}2 according to Embodiment 3.

The second transfer control unit 222 in the subsequent unit 220 restores the intermediate data from the main memory 20 (S241). More specifically, the intermediate data is read from the main memory 20.

When the second transfer control unit 222 reads a header as intermediate data (Yes in S242), the second transfer control unit 222 measures the coding amount of the read data and compares the measurement result with the total coding amount of headers (S243). The header is transmitted to the second processing unit 221.

When the read intermediate data is not a header (No in S242), that is, when the second transfer control unit 222 reads quantized data, the second transfer control unit 222 transmits the quantized data to the second processing unit 221.

The extracting unit 225 in the second processing unit 221 extracts probability information from the quantized data (S244). The extracted probability information is provided to the second coding unit 226. The second coding unit 226 identifies, updates, and others the probability table to be used for arithmetic coding of quantized data corresponding to the probability information, using the probability information (S245).

Furthermore, the coding amount of the quantized data is measured and the measurement result is compared with the total coding amount of quantized data (S246).

The second coding unit 226 performs binarization (S247) and arithmetic coding (S248) on the quantized data. In the arithmetic coding, the probability table updated in S245 is referred to.

Furthermore, the second transfer control unit 222 performs termination processing (S250) when the second transfer control unit 222 detects that the end of the header or the end of the quantized data is to be processed (Yes in S249).

Subsequently, for example, when the data to be processed is the end of a picture (Yes in S251), the second coding unit 226 generates and outputs a stream in which arithmetic coded headers for one picture followed by arithmetic coded quantized data corresponding to the headers. When the data to be processed is not the end of a picture (No in S251), coding_{—}2 is performed again.

In such a manner, in the stream generation apparatus 200 according to Embodiment 3, as in Embodiments 1 and 2, the first processing unit 211 in the preceding unit 210 generates intermediate data into which coding-related information that is information to be used for arithmetic coding of the quantized data is inserted.

In Embodiment 3, information necessary for arithmetic coding of quantized data, such as probability information, is inserted into the quantized data as coding-related information. Furthermore, the quantized data which includes information necessary for arithmetic coding of the quantized data is stored in the main memory 20 as intermediate data without being binarized and arithmetic coded.

Hence, the extracting unit 225 in the subsequent unit 220 which has received such intermediate data from the main memory 20 is capable of easily extracting information necessary for arithmetic coding of the quantized data, from the quantized data included in the intermediate data. As a result, it is possible to efficiently generate a stream on which arithmetic coding and data partitioning have been performed.

Information necessary for arithmetic coding of quantized data is inserted into the quantized data by being replaced with quantized DCT coefficient data of high-frequency domain (high-frequency component data) in the quantized data. This restricts a decrease in processing efficiency of the intermediate data, while maintaining the substantial image quality.

As described above, the stream generation apparatus 200 according to Embodiment 3 efficiently generates a stream having both high error tolerance and high compression rate,

### Supplement for Embodiments 1 to 3

In each of Embodiments 1 to 3, intermediate data that is input data, which includes coding-related information and on which the first processing has been performed, is transferred to the main memory 20 from the preceding unit 210. Here, the headers, which are included in the intermediate data and on which processing up to and including arithmetic coding has been performed, and quantized data, which is included in the intermediate data and on which no processing has been performed after input, are stored in different storage areas.

It may be that the main memory 20 which has such a function is replaced with two physically different memories and that one of the memories stores headers and the other memory stores quantized data.

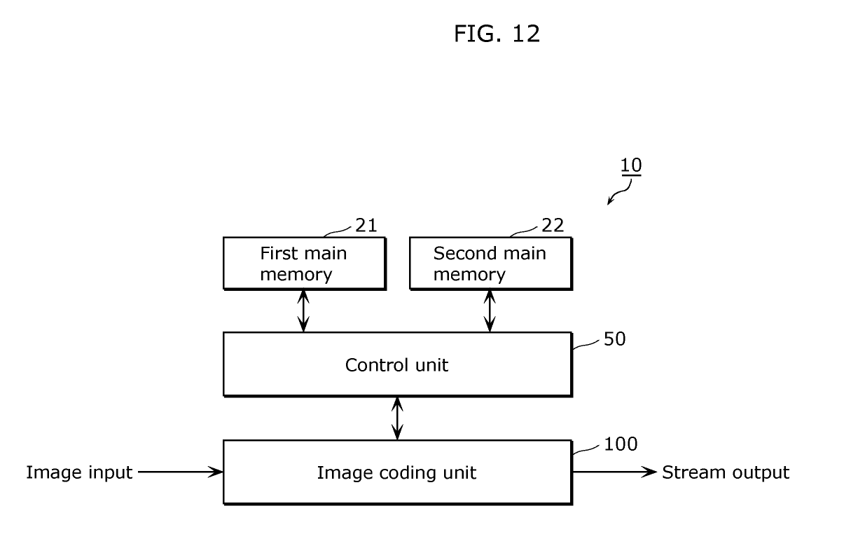

FIG. 12 is a block diagram schematically showing a configuration where the image coding apparatus 10 includes two memories for saving intermediate data.

More specifically, the image coding unit 100 is connected to a first main memory 21 and a second main memory 22 via the control unit 50.

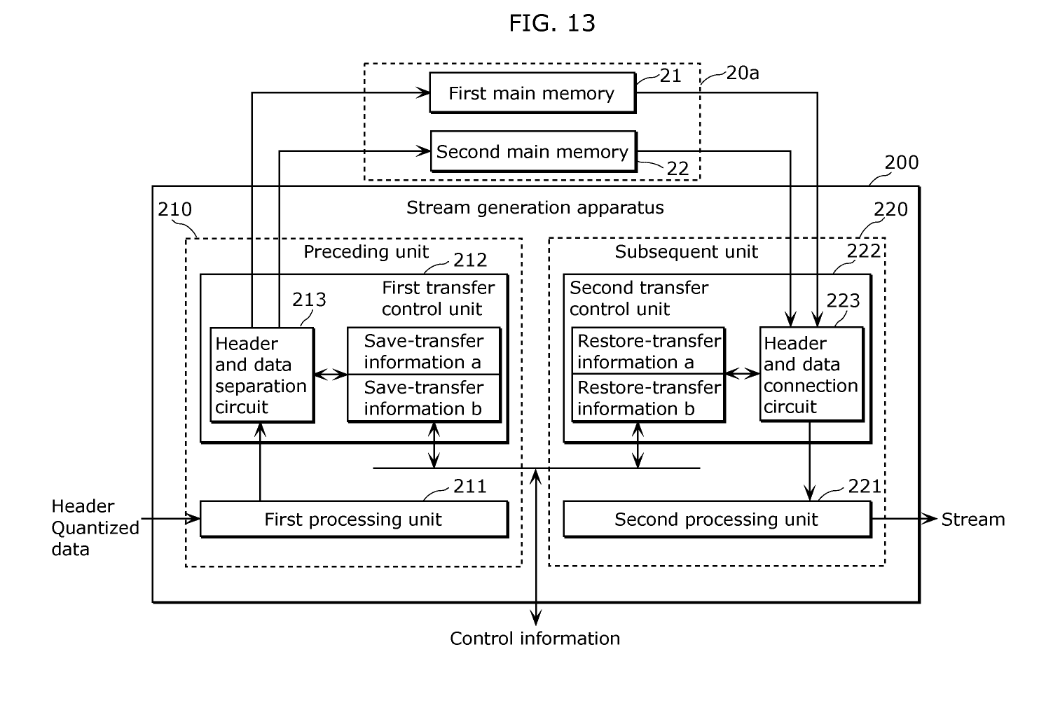

FIG. 13 is a block diagram schematically showing a configuration where the stream generation apparatus 200 is connected to the first main memory 21 and the second main memory 22.

In FIG. 13, it is assumed that the first main memory 21 stores headers and the second main memory 22 stores quantized data, for example. More specifically, the storage unit 20a for temporarily storing intermediate data includes the first main memory 21 and the second main memory 22. In such a case, the following processing is performed.

The first transfer control unit 212 transfers the intermediate data generated by the first processing unit 211 to the storage unit 20a (i) to store, in the first main memory 21 in the storage unit 20a, headers which are included in the intermediate data and on which the first processing has been performed, and (ii) to store quantized data, which is included in the intermediate data and on which the first processing has been performed, in the second main memory 22 which is included in the storage unit 20a and which is physically different from the first main memory 21.

More specifically, a header and data separation circuit 213 in the first transfer control unit 212 transfers arithmetic coded headers to the first main memory 21 according to save-transfer information a. The header and data separation circuit 213 also transfers quantized data on which binarization and arithmetic coding have not been performed, to the second main memory 22 according to save-transfer information b.

A header and data connection circuit 223 in the second transfer control unit 222 obtains, from the first main memory 21, headers for a predetermined unit, such as a picture, according to the restore-transfer information a. The header and data connection circuit 223 also obtains, from the second main memory 22, quantized data items for the predetermined unit, according to the restore-transfer information b.

As described above, even when two storage areas used by the stream generation apparatus 200 for saving intermediate data exist in two physically different memories, it is possible to obtain the advantageous effects similar to the case where the storage areas exist in a single memory. More specifically, it is possible to separately process the headers and quantized data easily in the stream generation process. As a result, it is possible to generate a stream on which arithmetic coding and data partitioning have been performed.

Descriptions have been given of Embodiments 1 to 3 and supplement of the stream generation apparatus and the stream generation method according to the present invention. However, the present invention is not limited to such embodiments and the supplement thereof. Those skilled in the art will readily appreciate that various modifications may be made in these exemplary embodiments without materially departing from the principles and spirit of the inventive concept, the scope of which is defined in the appended Claims and their equivalents.

For example, in Embodiments 1 to 3 (and supplement for these embodiments, hereinafter, simply referred to Embodiments 1 to 3), the first processing unit 211 in the stream generation apparatus 200 does not perform binarization and arithmetic coding on quantized data.

However, it may be that the first processing unit 211 binarizes the quantized data. Also in cases where quantized data is binarized, if the relation of the sizes of the quantized data before binarization and binarized quantized data is defined by a function or the like, the second processing unit 221 is capable of dividing the binarized quantized data on a per-macroblock basis, using the section information.

In Embodiments 1 to 3, descriptions have been given of cases where the stream generation apparatus 200 performs arithmetic coding which involves data partitioning. However, the present invention is not limited to the example.

More specifically, even if an apparatus is not intended to have a technique referred to as “data partitioning”, but the apparatus stores headers and quantized data in different portions in a stream and generates the stream by performing processing after quantization in two stages, the present invention is applicable to such an apparatus.

Furthermore, in Embodiments 1 to 3, binarization is used as variable-length coding, and arithmetic coding is used as compression coding. However, the present invention is not limited to the example.

For example, in coding processing where processing after quantization is performed in two stages, the present invention is applicable if an apparatus performs variable-length coding on data in the preceding stage, and a set of coding processing where a predetermined amount of processing results of the preceding stage is collectively compressed in the subsequent stage.

Furthermore, part or all of the structural elements of each stream generation apparatus 200 may be a module of a program executed by a CPU or the like.

More specifically, in each embodiment above, each of the structural elements may be configured by a dedicated hardware, or may be implemented by executing a software program suitable for each structural element. Each of the structural elements may be implemented by a program executing unit, such as a CPU or a processor, reading a software program recorded on a hard disk or a recording medium such as a semiconductor memory, and executing the program. Here, the software which implements the stream generation apparatus 200 is a program as described below.

More specifically, the program causes a computer to execute the following stream generation method. A stream generation method of generating a stream by performing variable-length coding and compression coding on input data including quantized data which is quantized image data and a header corresponding to the quantized data. The stream generation method includes: inserting, into the header, coding-related information which is information for identifying a position of necessary information in the header, the necessary information being information necessary for the compression coding of the quantized data; performing first processing on the input data in a state before or after the insertion of the coding-related information, the first processing including the variable-length coding and the compression coding of the header; transferring intermediate data to a storage unit, the intermediate data being the input data which includes the coding-related information and on which the first processing has been performed; reading the intermediate data from the storage unit; extracting the necessary information from the position in the header indicated by the coding-related information, the header being included in the read intermediate data; and generating the stream by performing second processing including the compression coding of the quantized data which is included in the read intermediate data and on which the first processing has been performed, the compression coding being performed using the necessary information extracted in the extracting.

The stream generation method may include: obtaining coding-related information from the header and inserting the obtained coding-related information into the input data, the coding-related information being necessary information for the compression coding of the quantized data; performing first processing on the input data in a state before or after the insertion of the coded related information, the first processing including the variable-length coding and the compression coding of the header; transferring intermediate data to a storage unit, the intermediate data being the input data which includes the coding-related information and on which the first processing has been performed; reading the intermediate data from the storage unit; extracting the coding-related information from the read intermediate data; and generating the stream by performing second processing including the compression coding of the quantized data which is included in the read intermediate data and on which the first processing has been performed, the compression coding being performed using the coding-related information extracted in the extracting.

Furthermore, part or all of the structural elements of each stream generation apparatus 200 may be configured from a single system large scale integration (LSI).

The System LSI is a super-multi-function LSI manufactured by integrating structural elements on one chip, and is specifically a computer system configured by including a microprocessor, a read only memory (ROM), a random access memory (RAM), and so on.

Furthermore, the present invention may be implemented as a stream generation method including the operations of the characteristic units included in the stream generation apparatus 200. Furthermore, the present invention may be implemented as a program causing a computer to execute each step included in the stream generation method.

Furthermore, the present invention may be implemented as a computer-readable recording medium storing such a program. Such a program may be distributed via a transmission medium such as the Internet.

### INDUSTRIAL APPLICABILITY

The present invention provides a stream generation apparatus and a stream generation method which efficiently generate a stream having both high error tolerance and high compression rate. The present invention is useful as a stream generation apparatus and the like which is included in an apparatus which performs compression coding on image data for output.

1. A stream generation apparatus which generates a stream by performing variable-length coding and compression coding on input data including quantized data which is quantized image data and a header corresponding to the quantized data, the stream generation apparatus comprising:
an inserting unit configured to insert, into the header, coding-related information which is information for identifying a position of necessary information in the header, the necessary information being information necessary for the compression coding of the quantized data;
a first coding unit configured to perform first processing on the input data in a state before or after the insertion of the coding-related information, the first processing including the variable-length coding and the compression coding of the header;
a first transfer control unit configured to transfer intermediate data to a storage unit connected to the stream generation apparatus, the intermediate data being the input data which includes the coding-related information and on which the first processing has been performed;
a second transfer control unit configured to read the intermediate data from the storage unit;
an extracting unit configured to extract the necessary information from the position in the header indicated by the coding-related information, the header being included in the read intermediate data; and
a second coding unit configured to generate the stream by performing second processing including the compression coding of the quantized data which is included in the read intermediate data and on which the first processing has been performed, the compression coding being performed using the necessary information extracted by the extracting unit.

2. The stream generation apparatus according to claim 1,
wherein the inserting unit is configured to insert, as the coding-related information, a flag before the necessary information and a flag after the necessary information, the two flags being information for identifying the position of the necessary information in the header, and
the extracting unit is configured to extract the necessary information located between the two flags.

3. The stream generation apparatus according to claim 1,
wherein the inserting unit is configured to insert a flag before the necessary information, as the coding-related information, the flag being information for identifying the position of the necessary information in the header, the flag indicating a starting position and a size of the necessary information, and
the extracting unit is configured to extract the necessary information, based on the starting position and the size indicated by the flag.

4. A stream generation apparatus which generates a stream by performing variable-length coding and compression coding on input data including quantized data which is quantized image data and a header corresponding to the quantized data, the stream generation apparatus comprising:
an inserting unit configured to obtain coding-related information from the header and insert the obtained coding-related information into the input data, the coding-related information being necessary information for the compression coding of the quantized data;
a first coding unit configured to perform first processing on the input data in a state before or after the insertion of the coding-related information, the first processing including the variable-length coding and the compression coding of the header;
a first transfer control unit configured to transfer intermediate data to a storage unit connected to the stream generation apparatus, the intermediate data being the input data which includes the coding-related information and on which the first processing has been performed;
a second transfer control unit configured to read the intermediate data from the storage unit;
an extracting unit configured to extract the coding-related information from the read intermediate data; and
a second coding unit configured to generate the stream by performing second processing including the compression coding of the quantized data which is included in the read intermediate data and on which the first processing has been performed, the compression coding being performed using the coding-related information extracted by the extracting unit.

5. The stream generation apparatus according to claim 4,
wherein the inserting unit is configured to insert the coding-related information immediately after non-compressed data in the input data, and
the extracting unit is configured to extract the coding-related information inserted immediately after the non-compressed data.

6. The stream generation apparatus according to claim 4,
wherein the inserting unit is configured to insert the coding-related information into the quantized data, and
the extracting unit is configured to extract the coding-related information from the quantized data in the intermediate data.

7. The stream generation apparatus according to claim 6,
wherein the inserting unit is configured to insert the coding-related information into the quantized data by replacing high-frequency component data included in the quantized data with the necessary information.

8. The stream generation apparatus according to claim 1,
wherein the first transfer control unit is configured to transfer the intermediate data to the storage unit (i) to store, in a first memory included in the storage unit, the header which is included in the intermediate data and on which the first processing has been performed, and (ii) to store, in a second memory included in the storage unit, the quantized data which is included in the intermediate data and on which the first processing has been performed, the second memory being physically different from the first memory.

9. The stream generation apparatus according to claim 1,
wherein the first coding unit is configured to perform the first processing including (i) the variable length coding and the compression coding of the header and (ii) inputting of the quantized data to the first transfer control unit, and
the second coding unit is configured to perform the second processing including the variable-length coding and the compression coding of the quantized data which is included in the read intermediate data and on which the first processing has been performed.

10. The stream generation apparatus according to claim 1,
wherein the first coding unit is configured to perform the first processing including (i) the variable length coding and the compression coding of the header and (ii) the variable length coding of the quantized data.

11. The stream generation apparatus according to claim 4,
wherein the first transfer control unit is configured to transfer the intermediate data to the storage unit (i) to store, in a first memory included in the storage unit, the header which is included in the intermediate data and on which the first processing has been performed, and (ii) to store, in a second memory included in the storage unit, the quantized data which is included in the intermediate data and on which the first processing has been performed, the second memory being physically different from the first memory.

12. The stream generation apparatus according to claim 4,
wherein the first coding unit is configured to perform the first processing including (i) the variable length coding and the compression coding of the header and (ii) inputting of the quantized data to the first transfer control unit, and
the second coding unit is configured to perform the second processing including the variable-length coding and the compression coding of the quantized data which is included in the read intermediate data and on which the first processing has been performed.

13. The stream generation apparatus according to claim 4,
wherein the first coding unit is configured to perform the first processing including (i) the variable length coding and the compression coding of the header and (ii) the variable length coding of the quantized data.

14. A stream generation method of generating a stream by performing variable-length coding and compression coding on input data including quantized data which is quantized image data and a header corresponding to the quantized data, the stream generation method comprising:
inserting, into the header, coding-related information which is information for identifying a position of necessary information in the header, the necessary information being information necessary for the compression coding of the quantized data;
performing first processing on the input data in a state before or after the insertion of the coding-related information, the first processing including the variable-length coding and the compression coding of the header;
transferring intermediate data to a storage unit, the intermediate data being the input data which includes the coding-related information and on which the first processing has been performed;
reading the intermediate data from the storage unit;
extracting the necessary information from the position in the header indicated by the coding-related information, the header being included in the read intermediate data; and
generating the stream by performing second processing including the compression coding of the quantized data which is included in the read intermediate data and on which the first processing has been performed, the compression coding being performed using the necessary information extracted in the extracting.

15. A stream generation method of generating a stream by performing variable-length coding and compression coding on input data including quantized data which is quantized image data and a header corresponding to the quantized data, the stream generation method comprising:
obtaining coding-related information from the header and inserting the obtained coding-related information into the input data, the coding-related information being necessary information for the compression coding of the quantized data;
performing first processing on the input data in a state before or after the insertion of the coded related information, the first processing including the variable-length coding and the compression coding of the header;
transferring intermediate data to a storage unit, the intermediate data being the input data which includes the coding-related information and on which the first processing has been performed;
reading the intermediate data from the storage unit;
extracting the coding-related information from the read intermediate data; and
generating the stream by performing second processing including the compression coding of the quantized data which is included in the read intermediate data and on which the first processing has been performed, the compression coding being performed using the coding-related information extracted in the extracting.

16. An integrated circuit which generates a stream by performing variable-length coding and compression coding on input data including quantized data which is quantized image data and a header corresponding to the quantized data, the integrated circuit comprising:
an inserting unit configured to insert, into the header, coding-related information which is information for identifying a position of necessary information in the header, the necessary information being information necessary for the compression coding of the quantized data;
a first coding unit configured to perform first processing on the input data in a state before or after the insertion of the coding-related information, the first processing including the variable-length coding and the compression coding of the header;
a first transfer control unit configured to transfer, to a storage unit connected to the integrated circuit, intermediate data which is the input data which includes the coding-related information and on which the first processing has been performed;
a second transfer control unit configured to read the intermediate data from the storage unit;
an extracting unit configured to extract the necessary information from the position in the header indicated by the coding-related information, the header being included in the read intermediate data; and
a second coding unit configured to generate the stream by performing second processing which includes the compression coding using the information extracted by the extracting unit, the second processing including the compression coding on the quantized data which is included in the read intermediate data and on which the first processing has been performed.

17. An integrated circuit which generates a stream by performing variable-length coding and compression coding on input data including quantized data which is quantized image data and a header corresponding to the quantized data, the integrated circuit comprising:
an inserting unit configured to obtain coding-related information from the header and insert the obtained coding-related information into the input data, the coding-related information being necessary information for the compression coding of the quantized data;
a first coding unit configured to perform first processing on the input data in a state before or after the insertion of the coding-related information, the first processing including the variable-length coding and the compression coding of the header;
a first transfer control unit configured to transfer intermediate data to a storage unit connected to the integrated circuit, the intermediate data including the coding-related information and being the input data on which the first processing has been performed;
a second transfer control unit configured to read the intermediate data from the storage unit;
an extracting unit configured to extract the coding-related information from the read intermediate data; and
a second coding unit configured to generate the stream by performing second processing including the compression coding of the quantized data which is included in the read intermediate data and on which the first processing has been performed, the compression coding being performed using the coding-related information extracted by the extracting unit.
